(19) United States
(12) Patent Application Publication
(10) Pub. No.: US 2010/0139073 A1
(43) Pub. Date: Jun. 10, 2010

(54) METHOD OF PRODUCING GOLF CLUB WOOD HEAD USING FOLDED METAL STRIP OR SHEET

(75) Inventor: J. ANDREW GALLOWAY, ESCONDIDO, CA (US)

Correspondence Address: CALLAWAY GOLF C0MPANY, 2180 RUTHERFORD ROAD, CARLSBAD, CA, 92008-7328, US

(73) Assignee: CALLAWAY GOLF COMPANY, CARLSBAD, CA (US)

(21) Appl. No.: 12/621,859

(22) Filed: Nov. 19, 2009

Related U.S. Application Data
(60) Provisional application No. 61/120,255, filed on Dec. 5, 2008.

(51) Int. Cl. B23P 11/00; B23P 15/00; B23P 17/00; B21D 22/02

(52) U.S. Cl. 29/428; 72/379.2; 72/364; 29/527.1

(57) ABSTRACT

A method for forming a face component 40 for a golf club head from a sheet of high strength metallic material is disclosed herein. The face component has a center portion 50 with a greater thickness than other portions 52 and this greater thickness portion is formed in the original sheet of material.

### CROSS REFERENCES TO RELATED APPLICATIONS

The present application claims priority to U.S. Provisional Patent Application No. 61/120,255, filed on Dec. 5, 2008.

### STATEMENT REGARDING FEDERALLY SPONSORED RESEARCH OR DEVELOPMENT

Not Applicable

### BACKGROUND OF THE INVENTION

1. Field of the Invention

The present invention relates to manufacturing a golf club head. More specifically, the present invention relates to manufacturing a wood-type golf club head from multiple pieces.

2. Description of the Related Art

Golf club heads such as drivers and fairway woods utilize a variety of constructions. In general the golf club heads are assembled mostly by welding compatible metal alloys into a closed volume. The hitting surface is designed to provide the necessary geometry for desired trajectory and the necessary structure to survive ball impact over the expected life of the golf club head. Recently, through the use of stronger alloys, metals and processing, the face has been made more compliant, thus increasing the ball speed off the face for a given speed, the coefficient of restitution (“COR”). The COR is restricted to 0.83, which is hard to achieve in investment cast golf club heads, and most golf clubs fall short of this performance.

The club materials and gages have also been changing in terms of metals, alloys and construction. The rotational inertia of the golf club head is optimized and increased by increasing the enclosed volume of the club head but at a constant overall mass. To achieve this configuration, thinner materials or a combination of lighter (low density) materials and localized secondary mass materials is utilized. In general, these design directions increase the cost of the golf club head and limit the vendor/supplier base.

Striking plate materials consist of wrought sheet or forged components of titanium alloy or ultra high strength stainless steel. The subcomponents of the golf club head are then welded to a cast or fabricated metal body or are bonded to a non-metallic body. The shaping, heat treating and joining of these components increases both the raw material cost, but also increases the manufacturing cost of the club heads.

The prior art discloses several methods for forming a golf club head.

One method is full casting which involves casting the entire golf club head, usually with a face pull tool. Duquette et al., U.S. Pat. No. 6,978,976 for a Magnetized Core With Pneumatic Release System For Creating A Wax Mold For A Golf Club Head describes certain aspects of the full casting method. Then a face insert is welded to the golf club head.

Another method is using a full casting method, using a face pull tool and then cutting a crown opening. A graphite crown is then bonded to cover the opening thereby forming a multiple material golf club head.

Yet another method is forming an entire golf club head from multiple pieces. In this method, several pieces (crown, sole, face and hosel) are welded together to form a precursor golf club head. Then, an opening is cut in the crown creating an opening. A graphite crown is then bonded to cover the opening thereby forming a multiple material golf club head.

Yet another method is a high performance multiple piece golf club head. This forming method involves making a multiple piece golf club head. The crown material needs to be of high quality expensive titanium so prior to welding the crown component to the sole component, the crown is chemically milled to the limits of drop tower durability. The chemical milling process is necessary to render the crown component to be competitive with graphite strength to weight ratio.

The current construction includes tacking a face component to sole (called face subassembly). Manually trim and tack crown to face subassembly. Fully weld face, crown, and sole (21 inches of weld). Grind weld and polish head.

Each of these prior art methods have drawbacks. Both multiple piece graphite crown and full casting require the manufacturer to produce a complete golf club head. The crown opening is then cut and replaced with a graphite crown. This is obviously wasteful because of the need to fabricate an entire golf club head and then removing a portion. The high performance multiple piece golf club head remedies this wastefulness by utilizing an expensive titanium material and which adds more cost to render the crown component weight competitive to graphite crowns.

### BRIEF SUMMARY OF THE INVENTION

The present invention overcomes the problems of the prior art by providing a unique means for fabricating a face component for a golf club head. The present invention overcomes the cost penalties of the current state of the art by creating the face component of the golf club head in a low-cost, mass-production process. The present invention can be made via a variety of these industrial processes and can have high performance features placed in the material form, in bulk, at the lowest possible cost stage.

The present invention creates a face component for a golf club head that can be welded to a metallic body, bonded to a non-metallic or metallic-hybrid body, or can be inserted into a molding for final contours and then bonded to additional body components to achieve the completed golf club head.

One unique aspect of the present invention is a continuous process method to create face thickness variation in strip.

Another unique advantage of the present invention is forming by cutting a pattern in a folding sheet or strip to create a golf club head.

Another unique advantage of the present invention is the use of progressive die stamping to create a golf club head.

Another unique advantage of the present invention is the use of hot forming of sheet/strip pattern to create a face component.

Another unique advantage of the present invention is the welding of sheet folded and formed face component for finishing.

Another unique advantage of the present invention is local welding of folded formed sheet/strip cup face to create a stable structure insert for further processing via over-molding elastomer(s) or plastic outer surface details.

Another unique advantage of the present invention is use of cold working of strip or sheet in multiple steps to create golf club face component.

Another unique advantage of the present invention is molding bond line details around a cup face flange for precision and cosmetic bonding advantage.

Another unique advantage of the present invention is an integral, flexible seal to minimize adhesive in cavity, minimizing weight and potential for loose adhesive causing rattles in use.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is a view of the components of the preferred embodiment of the golf club head of the present invention.

FIG. 2 is a front view of a golf club head of the present invention.

FIG. 3 is top plan view of the golf club head of the present invention.

FIG. 4 is a side view of the heel end of a golf club head of the present invention.

FIG. 5 is a side view of the toe end of a golf club head of the present invention.

FIG. 6 is a bottom plan view of a golf club head of the present invention.

FIG. 7 is a rear view of a golf club head of the present invention.

FIG. 8 is an isolated view of the face component.

FIG. 9 is a cross-sectional view of the face component.

FIG. 10 is a flow chart of the method of forming the face component of the golf club head of the present invention.

FIG. 11 is a flow chart of an alternative method of forming the face component of the golf club head of the present invention.

### DETAILED DESCRIPTION OF THE INVENTION

The method of manufacture allows the low cost implementation of a variable face thickness to increase compliance and reduce face mass. This method involves the custom rolling, extruding, machining or grinding of a thickness profile in the raw material strip/slit sheet before forming. In all these cases, but particularly effective with rolling and extruding is the ability to create a continuous profile efficiently. It is suggested that the middle of the face area in a horizontal path be thicker than the remaining areas of the strip. This is to minimize the material in the folded flanges and perimeter of the face, but maintain an increased thickness in the central region of the face extending horizontally and wrapping with the “ribbon” flanges to interface with the body.

This invention is a formed-shape likely in a face component form, which is utilized as the hitting portion of a wood-type golf club head.

The present invention is initiated as a custom strip of high strength metallic material with a greater thickness in the middle of the high strength metallic material 83. The alloy chosen will affect the forming process. Two basic materials approaches, two associated forming processes, and two configurations are preferred in practicing the present invention. Preferred material choices are a high strength titanium alloy or a stainless steel that are manufactured using a hot forming process. The hot forming process enables the metal to be deformed to the desired shape in minimal steps, preferably one or two steps. These materials include ultra high strength carbon steels such as 4340, Aero Met 100 and 310, titanium Beta and Alpha Beta alloys. After forming, these components can then be welded, to form a contiguously joined component, which is the first preferred configuration. This first preferred configuration requires a finishing operation of possibly straightening, grinding, and polishing.

The second preferred configuration has slight geometry changes to the formed component such as disjoined areas that are joined by welding, bonding or mechanical means. The second preferred configuration requires secondary processing such as the over-molding of an elastomer or plastic material.

The second material type includes materials, such as maraging 300, 250 and other stainless steels, are easily cold worked, to allow multiple forming steps without over work and then can be easily heat treated for a predetermined time and temperature to high strength levels. Both preferred configurations preferably utilize materials that can be welded together.

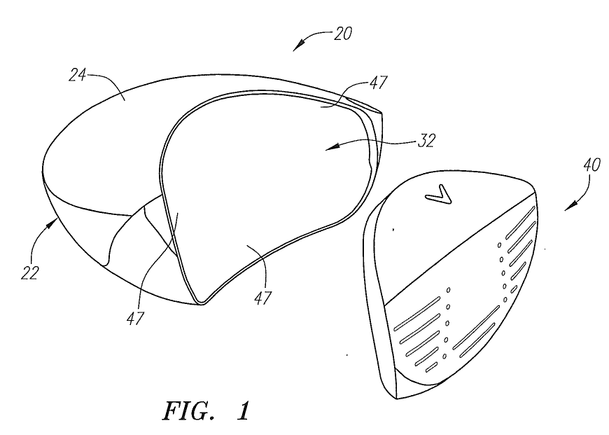

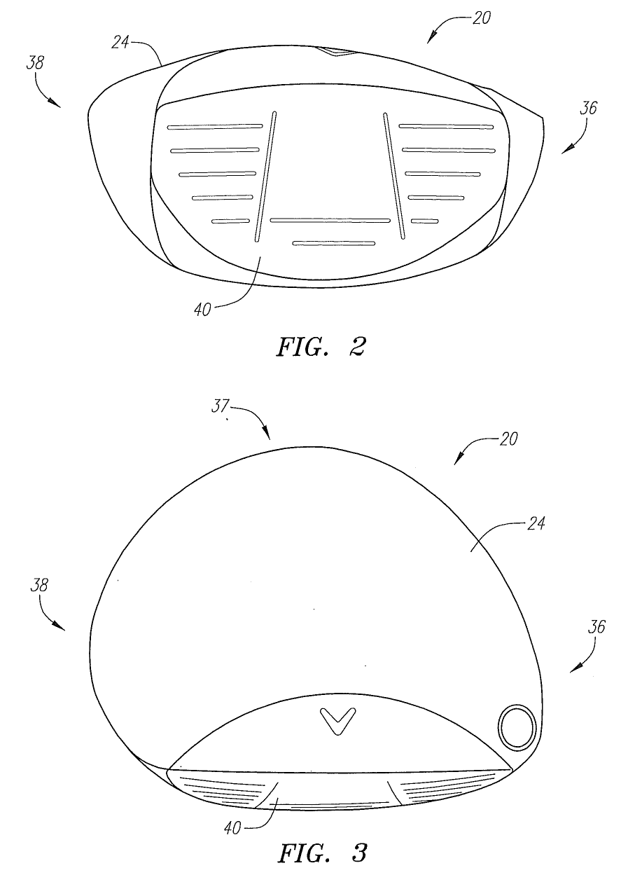

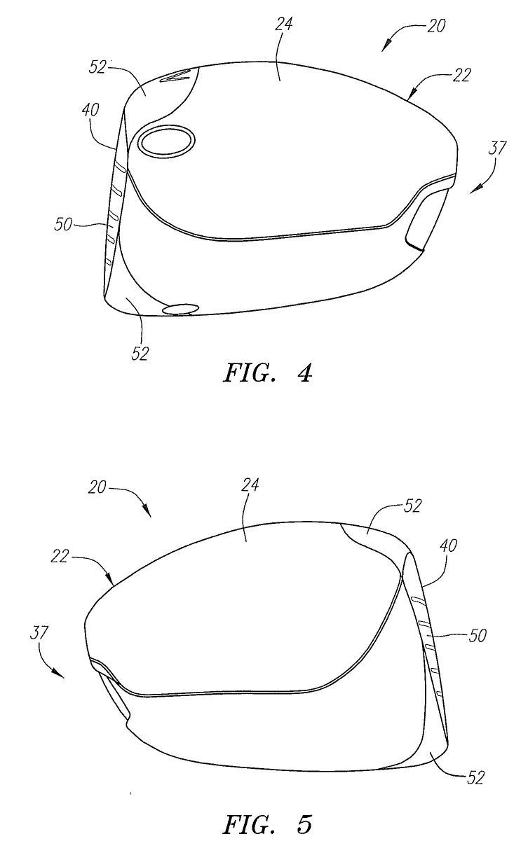

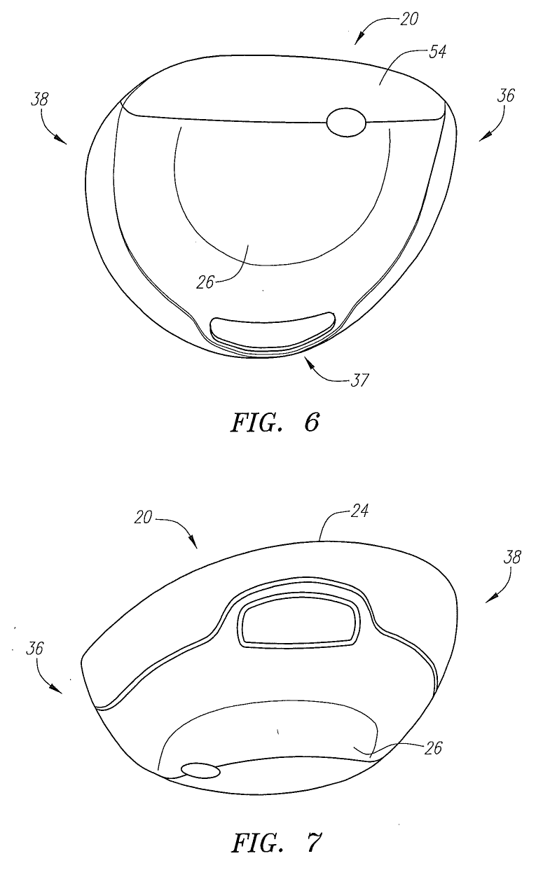

As shown in FIGS. 1-8, a golf club head 20 of the present invention is generally designated. The face component may be bonded to a body that is composed of a metallic body, a non-metallic or metallic-hybrid body.

The body 22 has a crown 24, a sole 26, a ribbon, and an opening extending into the crown 24 and the sole 26. The body 22 preferably has a hollow interior 47. The golf club head 20 also has a heel end 36, a toe end 38, and an aft end 37.

The golf club head 20 has a face component 40 that is attached to the body 22 over the opening 32. The method of forming the face component 40 being the present invention.

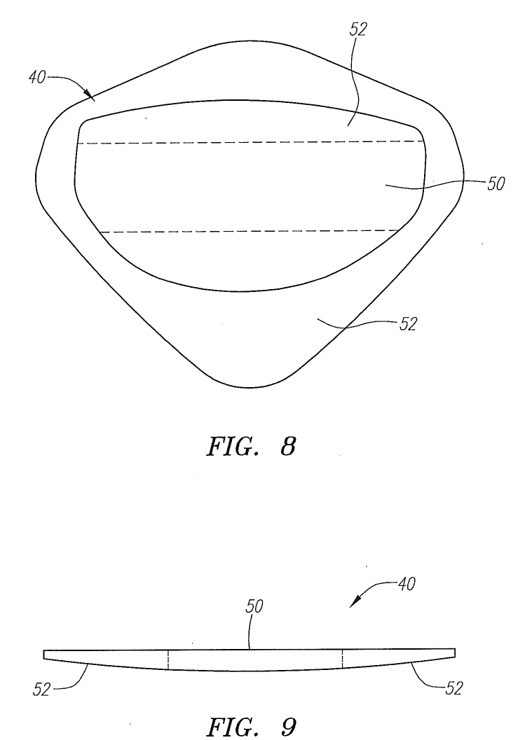

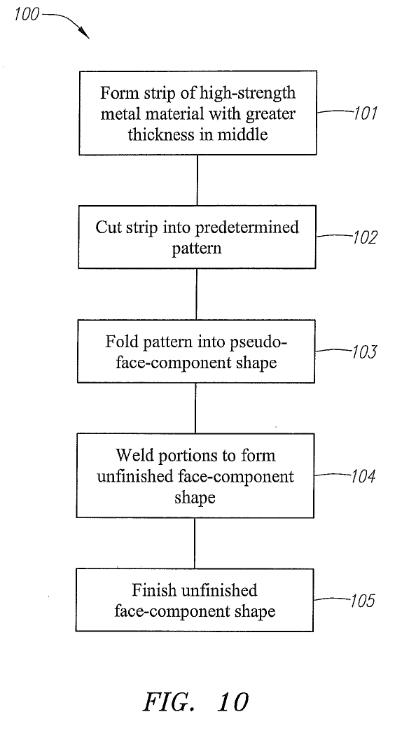

A method for forming a golf club head 20 as illustrated in FIG. 10 results in the first configuration. The first configuration of the present invention involves a method for creating a face component 40 for a golf club head. The method comprises forming a strip of high-strength metallic material having a greater thickness in the middle of the strip of high-strength metallic material 83 and cutting that strip of high-strength metallic material into a predetermined pattern of metal material. FIG. 9 illustrates a cross-sectional view of the thickness variation. The periphery region 52 has a thickness that tapers from the edge of the central region 50 to a final thickness. The next step involves folding the predetermined pattern into a pseudo-face component shape and then welding portions of the pseudo-face component shape to form an unfinished face component shape. The last step is finishing the unfinished face component shape, which may be accomplished by straightening, grinding, and polishing.

This method for forming a golf club head 20 is illustrated in FIG. 9 and generally designated 100. At block 101, a strip of high-strength metallic material having a greater thickness in the middle of the strip is formed. At block 102, the strip of high-strength metallic material is cut into a predetermined pattern. At block 103, the predetermined pattern is folded into a pseudo-face component shape. At block 104, portions of the pseudo-face component shape are welded to form an unfinished face component shape. And lastly, at block 105, the unfinished face component is finished.

Another aspect of the present invention comprises another method for creating a face component of a golf club head. This method results in the second configuration of the present invention. The method comprises forming a strip of high-strength metallic material having a greater thickness in the middle of the strip of high-strength metallic material and cutting the strip of high-strength metallic material 83 into a predetermined pattern of metal material. The predetermined pattern is folded into a pseudo-face component shape. The portions of the pseudo-face component shape are welded to form a stable structure insert face-component shape. Lastly, the stable structure insert face-component shape is overmolded with an elastomer or other plastic material for outer surface details.

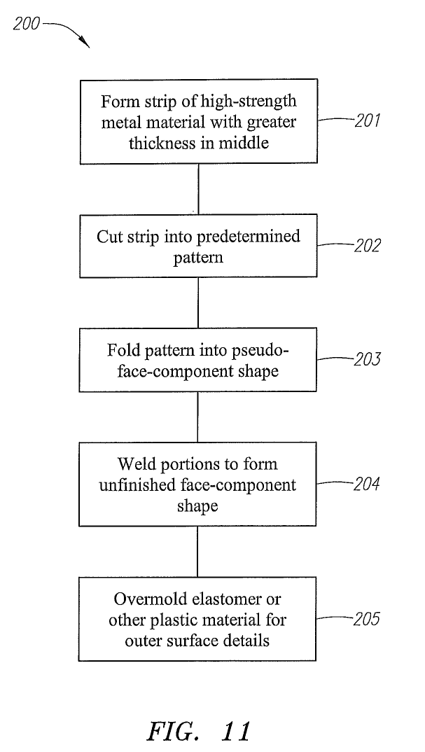

This method for forming a golf club head 20 is illustrated in FIG. 11 and generally designated 200. At block 201, a strip of high-strength metallic material having a greater thickness in the middle of the strip is formed. At block 202, the strip of high-strength metallic material is cut into a predetermined pattern. At block 203, the predetermined pattern is folded into a pseudo-face component shape. At block 204, portions of the pseudo-face component shape are welded to form an unfinished face component shape. And lastly, at block 105, there is an overmold of elastomer or other plastic material for outer surface details.

Another aspect of the present invention is a method for creating face thickness variation in material used for a face component of a golf club head. The method comprises die-stamping a strip of high-strength metallic material having a greater thickness 83 in the middle of the strip of high-strength metallic material to create a die-stamped sheet of material. The die-stamped sheet of material is then formed into a face component 40.

Yet another aspect of the present invention comprises molding bond line details around a flange of the face component 40, the molded bond line details providing a precision and cosmetic bonding advantage.

Another aspect involves providing an integral, flexible seal to minimize adhesive in a cavity of a golf club head formed from the face component 40.

Variable face thickness patterns of the striking plate insert are disclosed in U.S. Pat. No. 6,471,603, for a Contoured Golf Club Face, U.S. Pat. No. 6,368,234 for a Golf Club Striking Plate Having Elliptical Regions Of Thickness, U.S. Pat. No. 6,398,666 for a Golf Club Striking Plate With Variable Thickness, U.S. Pat. No. 7,448,960, for a Golf Club Head With Face Thickness which are all owned by Callaway Golf Company and which pertinent parts related to the face pattern are hereby incorporated by reference.

The present invention is directed at a golf club head that has a high coefficient of restitution thereby enabling for greater distance of a golf ball hit with the golf club head of the present invention. The coefficient of restitution (also referred to herein as “COR”) is determined by the following equation:

$$e = \frac{{v}_{2} - {v}_{1}}{{U}_{1} - {U}_{2}}$$

wherein U₁ is the club head velocity prior to impact; U₂ is the golf ball velocity prior to impact which is zero; v₁ is the club head velocity just after separation of the golf ball from the face of the club head; v₂ is the golf ball velocity just after separation of the golf ball from the face of the club head; and e is the coefficient of restitution between the golf ball and the club face.

The values of e are limited between zero and 1.0 for systems with no energy addition. The coefficient of restitution, e, for a material such as a soft clay or putty would be near zero, while for a perfectly elastic material, where no energy is lost as a result of deformation, the value of e would be 1.0. The present invention provides a club head having a coefficient of restitution ranging from 0.81 to 0.94, as measured under conventional test conditions.

The mass of the club head of the present invention ranges from 165 grams to 250 grams, preferably ranges from 175 grams to 230 grams, and most preferably from 190 grams to 205 grams. Preferably, the subassembly preferably has a mass ranging from 140 grams to 200 grams, more preferably ranging from 150 grams to 180 grams, yet more preferably from 155 grams to 166 grams, and most preferably 161 grams. The crown component has a mass preferably ranging from 4 grams to 20 grams, more preferably from 5 grams to 15 grams, and most preferably 7 grams.

The golf club head preferably has a volume that ranges from 290 cubic centimeters to 600 cubic centimeters, and more preferably ranges from 330 cubic centimeters to 510 cubic centimeters, even more preferably 350 cubic centimeters to 495 cubic centimeters, and most preferably 415 cubic centimeters or 460 cubic centimeters.

The axes of inertia are designated X, Y and Z. The X axis extends from the striking plate insert through the center of gravity, CG, and to the rear of the golf club head. The Y axis extends from the toe end of the golf club head through the center of gravity, CG, and to the heel end 66 of the golf club head. The Z axis extends from the crown section through the center of gravity, CG, and to the sole section.

As defined in Golf Club Design, Fitting, Alteration & Repair, 4^{th} Edition, by Ralph Maltby, the center of gravity, or center of mass, of the golf club head is a point inside of the club head determined by the vertical intersection of two or more points where the club head balances when suspended. A more thorough explanation of this definition of the center of gravity is provided in Golf Club Design, Fitting, Alteration & Repair.

The center of gravity and the moment of inertia of a golf club head are preferably measured using a test frame (X^{T}, Y^{T}, Z^{T}), and then transformed to a head frame (X^{H}, Y^{H}, Z^{H}). The center of gravity of a golf club head may be obtained using a center of gravity table having two weight scales thereon, as disclosed in U.S. Pat. No. 6,607,452, entitled High Moment Of Inertia Composite Golf Club, and hereby incorporated by reference in its entirety.

In general, the moment of inertia, Izz, about the Z axis for the golf club head preferably ranges from 2800 g-cm² to 5000 g-cm², preferably from 3000 g-cm² to 4500 g-cm², and most preferably from 3750 g-cm² to 4250 g-cm². The moment of inertia, Iyy, about the Y axis for the golf club head preferably ranges from 1500 g-cm² to 4000 g-cm², preferably from 2000 g-cm² to 3500 g-cm², and most preferably from 2400 g-cm² to 2900 g-cm². The moment of inertia, Ixx, about the X axis for the golf club head 40 preferably ranges from 1500 g-cm² to 4000 g-cm², preferably from 2000 g-cm² to 3500 g-cm², and most preferably from 2500 g-cm² to 3000 g-cm².

In general, the golf club head has products of inertia such as disclosed in U.S. Pat. No. 6,425,832, and is hereby incorporated by reference in its entirety. Preferably, each of the products of inertia, Ixy, Ixz and Iyz, of the golf club head 40 have an absolute value less than 100 grams-centimeter squared. Alternatively, the golf club head 40 has a at least one or two products of inertia, Ixy, Ixz and Iyz, with an absolute value less than 100 grams-centimeter squared.

The width, W, preferably ranges from 4.0 inches to 5.5 inches, and most preferably from 4.75 inches to 5.0 inches. The height, H, preferably ranges from 2.0 inches to 3.0 inches, and most preferably ranges from 2.40 inches to 2.65 inches. The length, L, preferably ranges from 3.5 inches to 4.5 inches, and most preferably from 4.0 inches to 4.25 inches. The golf club head 40 may have an aspect ratio such as disclosed in U.S. Pat. No. 6,338,683 for a Striking Plate For A Golf Club Head, assigned to Callaway Golf Company, and which pertinent parts are hereby incorporated by reference.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

I claim as my invention the following:

1. A method for creating a face component for a golf club head, the method comprising:
forming a strip of high-strength metallic material having a greater thickness in the middle of the strip of high-strength metallic material;
cutting the strip of high-strength metallic material into a predetermined pattern of metal material;
folding the predetermined pattern into a pseudo-face component shape;
welding portions of the pseudo-face component shape to form an unfinished face-component shape; and
finishing the unfinished face-component shape.

2. A method for creating face thickness variation in material used for a face component of a golf club head, the method comprising die-stamping a strip of high-strength metallic material having a greater thickness in the middle of the strip of high-strength metallic material to create a die-stamped sheet of material and forming a face component from the die-stamped sheet of material.

3. A method for creating face thickness variation in material used for a face component of a golf club head, the method comprising providing a strip of high-strength metallic material having a greater thickness in the middle of the strip of high-strength metallic material and hot-forming a face component from the sheet of material.

4. A method for creating a face component for a golf club head, the method comprising:
forming a strip of high-strength metallic material having a greater thickness in the middle of the strip of high-strength metallic material;
cutting the strip of high-strength metallic material into a predetermined pattern of metal material;
folding the predetermined pattern into a pseudo-face component shape;
welding portions of the pseudo-face component shape to form a stable structure insert face-component shape; and
overmolding elastomer or another plastic material for outer surface details on the stable structure insert face-component shape.

5. A method for creating a face component for a golf club head, the method comprising:
forming a strip of high-strength metallic material having a greater thickness in the middle of the strip of high-strength metallic material;
cutting the strip of high-strength metallic material into a predetermined pattern of metal material;
folding the predetermined pattern into a pseudo-face component shape;
welding portions of the pseudo-face component shape to form a stable structure insert face-component shape; and
molding bond line details around a flange of the face component wherein said molded bond line details provide a precision and cosmetic bonding advantage.
